(19) United States
(12) Patent Application Publication
(10) Pub. No.: US 2021/0125110 A1
(43) Pub. Date: Apr. 29, 2021

(54) PROCESSING DEVICE AND PROCESSING SYSTEM

(71) Applicant: TOYOTA JIDOSHA KABUSHIKI KAISHA, Aichi-ken (JP)

(72) Inventor: Keita YAMAZAKI, Nisshin-shi (JP)

(21) Appl. No.: 16/985,230

(22) Filed: Aug. 5, 2020

(30) Foreign Application Priority Data
Oct. 29, 2019 (JP) 2019-196705

(51) Int. Cl. G06Q 10/02; G08B 5/36; G06N 20/00

(52) U.S. Cl. CPC G06Q 10/02; G06N 20/00; G08B 5/36

(57) ABSTRACT

A processing server includes a receiving unit configured to receive a ride-booking request to ride on a vehicle, a determination unit configured to determine whether a passenger who has booked the ride-booking request received by the receiving unit requires a wheelchair space for a mobility device used by the passenger, and an instruction unit configured to give an instruction to change an arrangement of seats in order to secure the wheelchair space for the passenger when the determination unit determines that the wheelchair space is required.

### INCORPORATION BY REFERENCE

The disclosure of Japanese Patent Application No. 2019-196705 filed on Oct. 29, 2019 including the specification, drawings and abstract is incorporated herein by reference in its entirety.

### BACKGROUND

### 1. Technical Field

The present disclosure relates to a processing device and a processing system for booking a ride on a vehicle.

### 2. Description of Related Art

Japanese Unexamined Patent Application Publication No. 2008-065773 (JP 2008-065773 A) discloses a ride-booking receiving server that enables the booking of a priority seat and a wheelchair space in a bus for making it easy for a wheelchair user and a caregiver to get on and off the bus.

### SUMMARY

On the other hand, when a passenger who uses a wheelchair can book a ride using a server such as the one described in JP 2008-065733 A but when a seat space provided on the vehicle for a wheelchair is fixed, the seat space is left unused when there is no wheelchair user and, in that case, the space efficiency of the vehicle is reduced.

The present disclosure provides a processing device that prepares a required space according to a time when a mobility device passenger, such as a wheelchair user, gets on a vehicle, thus improving the space efficiency of the vehicle.

A first aspect of the present disclosure relates to a processing device including a receiving unit, a determination unit, and an instruction unit. The receiving unit is configured to receive a ride-booking request to ride on a vehicle. The determination unit is configured to determine whether a passenger requires a wheelchair space for a mobility device used by the passenger. The passenger is a passenger who has booked the ride-booking request received by the receiving unit. The instruction unit is configured to give an instruction to change an arrangement of seats in order to secure the wheelchair space for the passenger when the determination unit determines that the wheelchair space is required.

In the processing device according to the first aspect, when the receiving unit receives a ride-booking request, the determination unit determines whether the passenger, who has made the ride-booking request, requires the wheelchair space for the mobility device used by the passenger. When the determination unit determines that the passenger requires the wheelchair space, the instruction unit gives an instruction to the vehicle to change the arrangement of the seats for securing the wheelchair space for the passenger. Therefore, when a passenger who uses a mobility device, such as a wheelchair, rides on the vehicle, the processing device in this aspect prepares the required space according to the time when the passenger gets on the vehicle, improving the space efficiency of the vehicle.

A processing device in a second aspect is the processing device according to the first aspect. In this processing device, the determination unit may be configured to determine the wheelchair space based on physical information on the passenger and device information on the mobility device used by the passenger.

In the processing device according to the second aspect, the arrangement of seats may be determined based on the physical information and the device information received by the receiving unit. For example, when the physical information includes the information indicating that the lower limb is disabled and the device information includes the information related to a wheelchair, the processing device can provide the wheel chair space optimized for the passenger, who uses the mobility device, using table data in which the position of the corresponding wheelchair space is defined in advance.

A processing device in a third aspect is the processing device according to the first aspect. In this processing device, the determination unit may be configured to determine the wheelchair space based on physical information on the passenger and device information on the passenger that are input to a learned model. The learned model is a model generated using physical information on users who require the wheelchair space when getting on the vehicle and device information relating to mobility devices used by the users.

In the processing device according to the third aspect, the arrangement of the seats can be determined using the learned model obtained by training a neural network model by machine learning. By inputting the physical information, which is the information on a disabled part of the body, and the device information, which indicates whether to require the wheelchair, to the learned model, the processing device can provide the wheelchair space most suitable for the passenger who uses the mobility device.

A fourth aspect of the present disclosure relates to a processing system including the processing device according to any one of the first to third aspects and an output unit. The output unit may be configured to display, on a floor of the vehicle, a movement line between a ramp of the vehicle and the wheelchair space when the passenger who requires the wheelchair space gets on the vehicle or gets off the vehicle.

In the processing system according to the fourth aspect, the movement line between the ramp and the wheelchair space is displayed on the floor. This movement line allows the passenger heading toward the wheelchair space to move in the vehicle cabin without hesitation.

A processing system in a fifth aspect is the processing system according to the fourth aspect. In this processing system, the output unit may be configured to cause light emitting units corresponding to the movement line and light emitting units surrounding the wheelchair space to emit light. The light emitting units constitute a plurality of light emitting units installed on the floor.

In the processing system according to the fifth aspect, the movement line of the passenger and the wheelchair space to which the passenger moves are shown by light. This allows not only the passenger to move smoothly but also other passengers around the passenger to recognize the movement of the passenger who uses the wheelchair.

The present disclosure makes it possible to prepare a required space according to the time when the passenger who uses a mobility device, such as a wheelchair, gets on a vehicle, improving the space efficiency of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a seat arrangement changing system according to a first embodiment;

FIG. 2 is a block diagram showing a hardware configuration of a processing server in the first embodiment;

FIG. 3 is a block diagram showing an example of a functional configuration of a CPU in the processing server in the first embodiment;

FIG. 4 is a block diagram showing a flow of machine learning in the processing server in the first embodiment;

FIG. 5 is a plan view showing an arrangement of the seats in a vehicle in each embodiment;

FIG. 6 is a plan view showing a wheelchair space in a vehicle in each embodiment;

FIG. 7 is a block diagram showing a hardware configuration of a vehicle in the first embodiment;

FIG. 8 is a block diagram showing an example of a functional configuration of a CPU of a control device in the first embodiment;

FIG. 9 is a block diagram showing a flow from the time when a user makes a ride-booking request to the time when the user rides on a vehicle in the seat arrangement changing system in the first embodiment; and

FIG. 10 is a block diagram showing an example of a functional configuration of a CPU of a control device in a second embodiment.

### DETAILED DESCRIPTION OF EMBODIMENTS

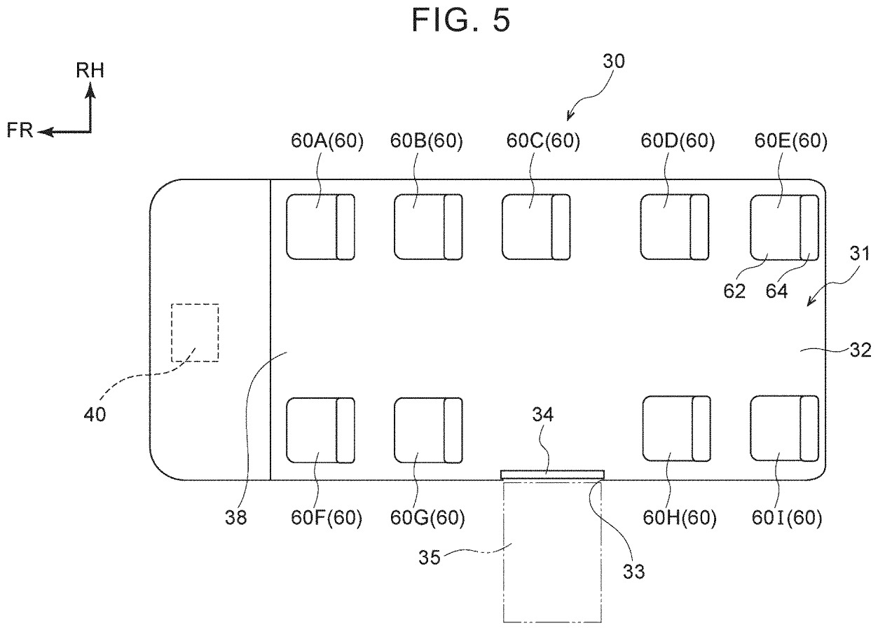

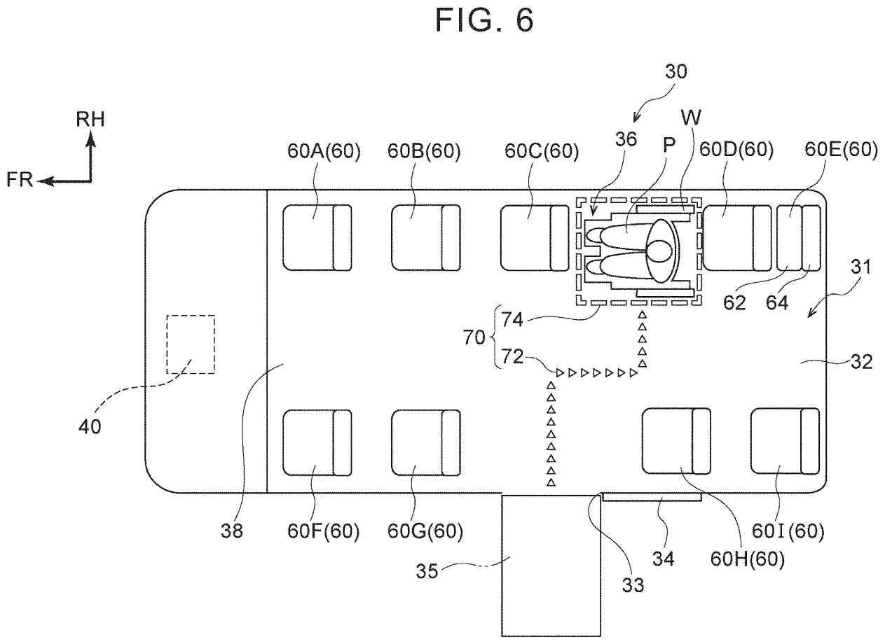

A processing system in an embodiment of the present disclosure will be described below with reference to the drawings. In FIG. 5 and FIG. 6, the arrow FR indicates the direction ahead of the vehicle, and the arrow RH indicates the right side in the vehicle width direction.

### First Embodiment

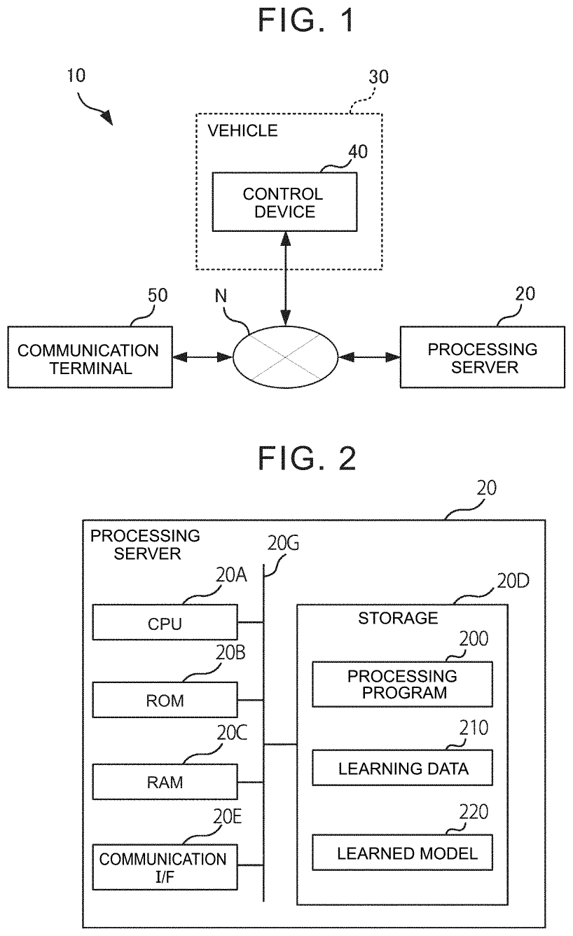

FIG. 1 is a block diagram showing a schematic configuration of a seat arrangement changing system 10 that is the processing system of this embodiment.

As shown in FIG. 1, the seat arrangement changing system 10 includes a processing server 20 that works as a processing device, a control device 40 mounted on a vehicle 30 that is an autonomous driving vehicle, and a communication terminal 50. The vehicle 30 in this embodiment, with a plurality of seats 60 in the vehicle cabin, enables the ride sharing of passengers (see FIG. 5). The processing server 20 performs reception processing for receiving a ride-booking request for a ride on the vehicle 30. This reception processing is performed when a user enters a request on the communication terminal 50. The communication terminal 50 is a communication device such as a smartphone, a tablet terminal, and the like. In the seat arrangement changing system 10, the processing server 20, control device 40, and communication terminal 50 are interconnected via a network N.

In FIG. 1, the seat arrangement changing system 10 has one vehicle 30, which includes the control device 40, and one communication terminal 50 for one processing server 20, but the number of vehicles 30 and the number of communication terminals 50 are not limited thereto. In other words, for one processing server 20, a plurality of vehicles 30, control devices 40, and communication terminals 50 may be provided.

### Processing Server

As shown in FIG. 2, the processing server 20 includes a central processing unit (CPU) 20A, a read only memory (ROM) 20B, a random access memory (RAM) 20C, a storage 20D, and a communication interface (I/F) 20E. The CPU 20A, ROM 20B, RAM 20C, storage 20D, and communication I/F 20E are communicably connected to each other via a bus 20G.

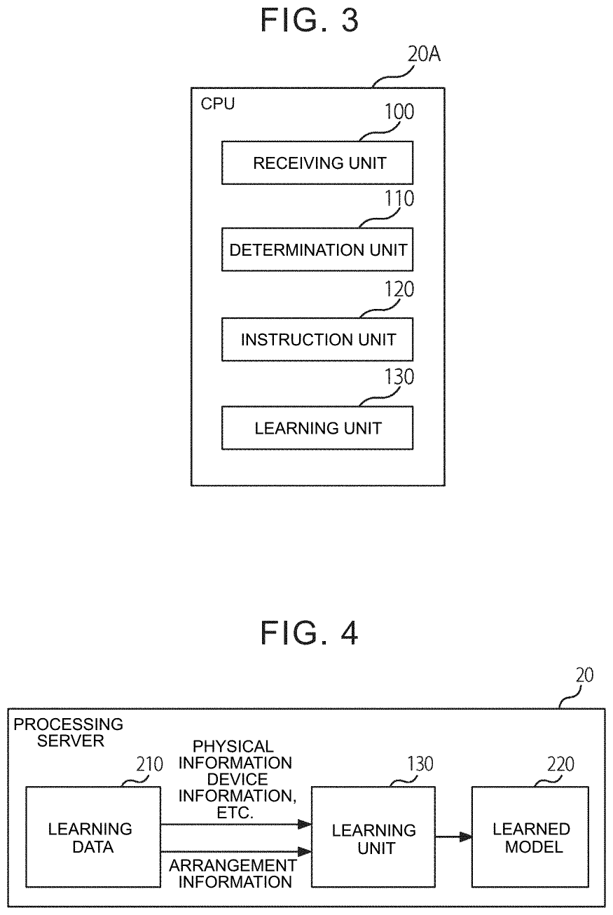

The CPU 20A is a central processing unit that executes various programs and controls the units. That is, the CPU 20A reads a program from the ROM 20B or the storage 20D for executing the program with the RAM 20C as a work area. In this embodiment, a processing program 200 is stored in the storage 20D. The CPU 20A functions as a receiving unit 100, a determination unit 110, an instruction unit 120, and a learning unit 130, all of which are shown in FIG. 3, when the processing program 200 is executed.

The ROM 20B stores various programs and various data. The RAM 20C is used as a work area for temporarily storing a program or data.

The storage 20D, configured by a hard disk drive (HDD) or a solid state drive (SSD), works as a storage unit for storing various programs and various data. More specifically, the storage 20D stores the processing program 200, learning data 210, and a learned model 220.

The processing program 200 is a program that performs the reception processing that will be described later. The learning data 210 is training data for performing machine learning in the processing server 20. The learned model 220 is data generated as a result of machine learning.

The communication I/F 20E is an interface for communicating with the control device 40 and the communication terminal 50. For example, a communication standard such as 5G, LTE, or Wi-Fi (registered trademark) is used for the communication I/F 20E.

FIG. 3 is a block diagram showing an example of a functional configuration of the CPU 20A. As shown in FIG. 3, the CPU 20A includes the receiving unit 100, determination unit 110, instruction unit 120, and learning unit 130. Each functional configuration is implemented by the CPU 20A that reads the processing program 200 from the storage 20D for execution.

The receiving unit 100 receives a ride-booking request for a ride on the vehicle 30. A ride-booking request is sent through the communication terminal 50 of the user who wants to ride on the vehicle 30.

The determination unit 110 determines whether the booked passenger P, who is received by the receiving unit 100, requires a wheelchair space 36 (see FIG. 6). In addition, the determination unit 110 in this embodiment determines the wheelchair space 36 that is optimized based on the physical information on the passenger P and the device information on the mobility device such as a wheelchair used by the passenger P. The physical information and the device information described above are those input to the learned model 220.

The instruction unit 120 gives an instruction to change the arrangement of the seats 60 for securing the wheelchair space 36 when the determination unit 110 determines that the passenger P requires the wheelchair space 36.

The learning unit 130 generates the learned model 220 associated with specific users who require the wheelchair space 36 when riding on the vehicle 30. The learning data 210 includes at least the physical information on specific users, the device information on a mobility device used by specific users, and the arrangement information on the position of the wheelchair space 36 that is optimal for specific users. As shown in FIG. 4, the learning unit 130 generates the learned model 220 by performing machine learning using the training data. In this training data, at least the physical information on specific users and the device information on specific users are used as the input and the arrangement information is used as the output. The learning data 210 may also include the information such as the sex, age, height, and weight of specific users.

For example, a deep neural network is used as the learned model 220 in this embodiment. To generate the learned model 220, a backpropagation method is used. For example, the learned model 220 is generated by training a deep neural network model by machine learning so that, when the physical information and the device information are input, the information indicating the optimal wheelchair space 36 for the passenger having the physical information and the device information is output. The output is, for example, a probability with which a specific wheelchair space 36 is allocated.

The processing server 20, configured as described above, uses the receiving unit 100, determination unit 110, and instruction unit 120 to perform the reception processing. The reception processing is a flow of processing in which a ride on the vehicle 30 is booked, whether the wheelchair space 36 is required is determined, and an instruction to change the arrangement of the seats 60 is issued to prepare the wheelchair space 36.

### Vehicle

As shown in FIG. 5, a plurality of seats 60 is arranged in a vehicle cabin 31 of the vehicle 30 in this embodiment. More specifically, on the right side in the vehicle width direction, the five seats 60, seat 60A to seat 60E, are sequentially arranged from the front side of the vehicle and, on the left side in the vehicle width direction, the four seats 60, seat 60F to seat 60I, are sequentially arranged from the front side of the vehicle.

Each of the seats 60 includes a frame (not shown) fixed to a floor 32 in such a way that the frame can be slid back and forth in longitudinal direction of the vehicle, a seat cushion 62 fixed to the frame and having a seat surface, and a seat back 64 fixed on the rear side of the seat cushion 62. The seat cushion 62 in this embodiment can spring up toward the seat back 64 (see the seat 60E in FIG. 6). This structure allows each of the seats 60 to be folded.

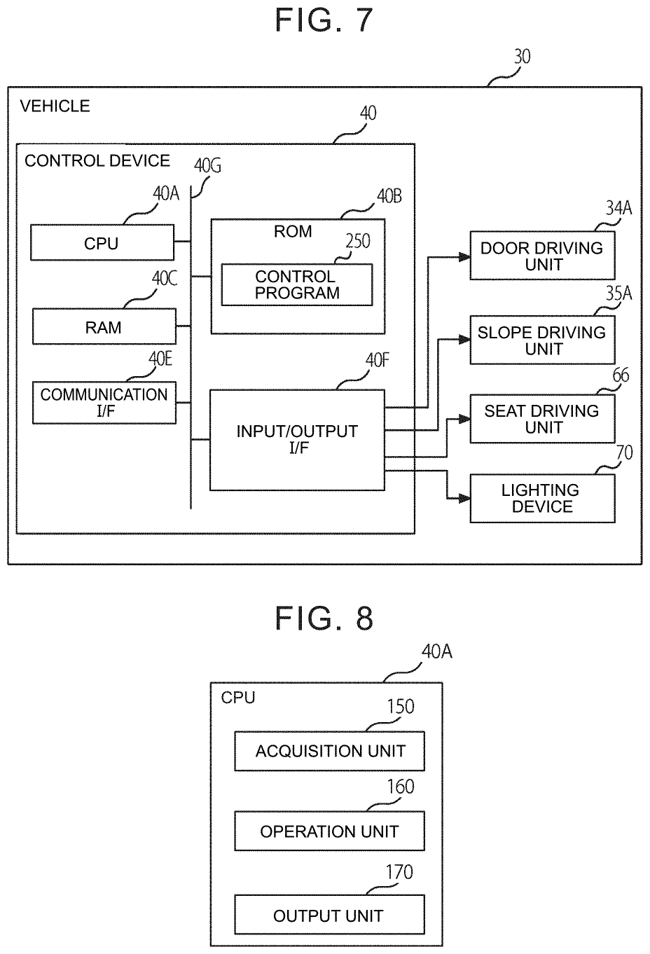

Furthermore, a seat driving unit 66 (see FIG. 7), which slides the frame and springs the seat cushion 62 toward the seat back 64, is connected to each of the seats 60.

In this embodiment, the wheelchair space 36, such as a space for a wheelchair W, can be provided by changing the arrangement of the seats 60. For example, as shown in FIG. 6, the wheelchair space 36 can be formed so that the wheelchair W can get in between the seat 60C and the seat 60D by folding the seat 60E and by sliding the seat 60D to the rear side of the vehicle.

The vehicle 30 in this embodiment has a ramp 33 on the left side in the vehicle width direction and between the seat 60G and the seat 60H. The ramp 33 is closed by a side door 34 that is opened to the rear side of the vehicle. The side door 34 can be opened and closed by a door driving unit 34A (see FIG. 7).

The ramp 33 has a slope 35 extending from the floor 32 toward the road surface. This slope 35 can be moved in the vehicle width direction by a slope driving unit 35A (see FIG. 7) and is configured to be stored below the floor 32.

As shown in FIG. 6, a lighting device 70 is embedded in the floor 32 in this embodiment. The lighting device 70 is configured by a plurality of LEDs. The lighting device 70 includes two types of light emitting units: passage light emitting units 72 arranged on a passage 38 and wheelchair space light emitting units 74 arranged around the wheelchair space 36. The lighting device 70 is an example of “a plurality of light emitting units”. The passage light emitting unit 72 is an example of “light emitting units corresponding to a movement line”. The wheelchair space light emitting units 74 is an example of “light emitting units surrounding the wheelchair space”.

As shown in FIG. 7, the control device 40 in this embodiment includes a CPU 40A, a ROM 40B, a RAM 40C, a communication I/F 40E, and an input/output I/F 40F. The CPU 40A, ROM 40B, RAM 40C, communication I/F 40E, and input/output I/F 40F are communicably connected to each other via a bus 40G. The functions of the CPU 40A, ROM 40B, RAM 40C, and communication I/F 40E are the same as those of the CPU 20A, ROM 20B, RAM 20C, and the communication I/F 20E of the processing server 20 described above.

The input/output I/F 40F is an interface for communicating with the devices mounted on the vehicle 30. To the control device 40 in this embodiment, the door driving unit 34A, slope driving unit 35A, seat driving unit 66, and lighting device 70 are connected via an input/output I/F 40F. The door driving unit 34A, slope driving unit 35A, seat driving unit 66, and lighting device 70 may be directly connected to the bus 40G.

The CPU 40A reads a program from the ROM 40B for executing the program with the RAM 40C as the work area. In this embodiment, the control program 250 is stored in the ROM 40B. The CPU 40A executes the control program 250 to function as the acquisition unit 150, operation unit 160, and output unit 170 shown in FIG. 8.

FIG. 8 is a block diagram showing an example of a functional configuration of the CPU 40A. As shown in FIG. 8, the CPU 40A includes an acquisition unit 150, an operation unit 160, and an output unit 170.

The acquisition unit 150 acquires the information sent from the processing server 20.

The operation unit 160 operates the side door 34, slope 35, and the seats 60. More specifically, the operation unit 160 outputs the drive signal to the door driving unit 34A, slope driving unit 35A, and seat driving unit 66 to operate these driving units.

The output unit 170 outputs the light emission signal, which causes the lighting device 70 to emit light, when the passenger P who requires the wheelchair space 36 gets on or off the vehicle 30. When the output unit 170 outputs the light emission signal, the passage light emitting units 72, extending from the ramp 33 to the wheelchair space 36, emit light. This light emission displays the movement line of the passenger P between the ramp 33 and the wheelchair space 36 on the floor 32. In addition, when the output unit 170 outputs the light emission signal, the wheelchair space light emitting units 74, which surround the wheelchair space 36, emit light.

### Operation

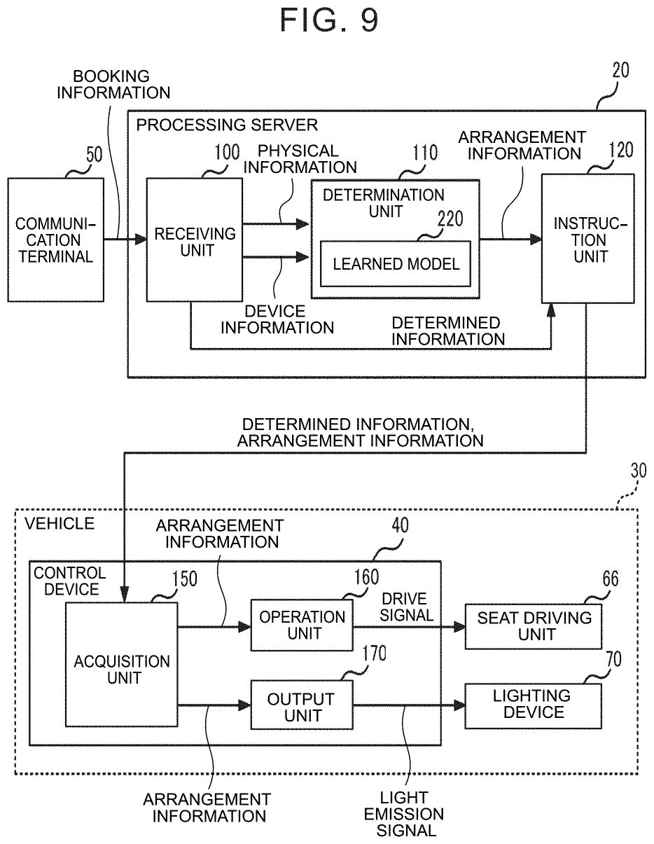

FIG. 9 shows a flow of the operation in the seat arrangement changing system 10 in this embodiment from the time a ride-booking request is issued to the time the passenger P gets on the vehicle.

First, the user who will be the passenger P of the vehicle 30 operates the communication terminal 50 to make a ride-booking request. The communication terminal 50 sends the booking information, entered through the user operation, to the processing server 20. The booking information includes the booking date and time, the ride section, the physical information on the passenger P, and the device information related to the mobility device such as a wheelchair. Examples of the physical information include the information indicating that the passenger P is disabled in the lower limbs, disabled in the left or right body, visually impaired, hearing impaired, and the like. Examples of the device information include the information indicating that the mobility device is a manual wheelchair, an electric wheelchair (joystick type), an electric cart (senior car), a walking car (silver car), a caster walker, and the like.

Next, the processing server 20 receives the booking information from the communication terminal 50 and performs the reception processing. First, the receiving unit 100, which has received the booking information, books the vehicle 30 on which the passenger P will get on, based on the booking date and time and the ride section included in the booking time.

Next, the determination unit 110 acquires at least the physical information and the device information, which are included in the booking information, from the receiving unit 100. The determination unit 110 enters the physical information on the passenger P and the device information on the passenger P into the learned model 220 and provides the arrangement information, output from the learned model 220, to the instruction unit 120. The arrangement information is the information on the arrangement of the seats 60 including the information on arrangement of the seats 60 on which healthy passengers will be seated. The arrangement information also includes the position information on the wheelchair space 36, the information on the seat 60 to be folded, and the information on the seat 60 to be slid.

Then, the instruction unit 120 sends the arrangement information acquired from the determination unit 110, as well as the determined information on the booking date and time and the ride section that are determined and acquired from the receiving unit 100, to the control device 40 of the vehicle 30.

On the other hand, the arrangement information and the determined information, which are sent to the control device 40, are acquired by the acquisition unit 150. The acquisition unit 150 identifies the riding date and time and the ride section of the passenger P based on the determined information. The acquisition unit 150 provides the arrangement information to the operation unit 160 and the output unit 170.

Then, when the vehicle 30 approaches the riding position of the passenger P and there is a need for preparing the wheelchair space 36, the operation unit 160 outputs the drive signal to the seat driving unit 66 of the seat 60 to be folded or to be slid, based on the arrangement information. As a result, the wheelchair space 36 is formed as shown in FIG. 6. In the example in FIG. 6, for the passenger P who uses the wheelchair W, the wheelchair space 36 is formed between the seat 60C and the seat 60D. The wheelchair space 36 formed in this way is close to the ramp 33 and is unlikely to get in the way of other passengers.

When the vehicle 30 arrives at the riding position of the passenger P, the operation unit 160 outputs the drive signal to the door driving unit 34A and the slope driving unit 35A. This drive signal causes the slope 35 to extend from the ramp 33 toward the road surface, and the side door 34 to open (see FIG. 6).

On the other hand, the output unit 170 outputs the light emission signal to the passage light emitting units 72, corresponding to the movement line from the ramp 33 to the wheelchair space 36, based on the arrangement information. In addition, when the wheelchair space 36 is formed, the output unit 170 outputs the light emission signal to the wheelchair space light emitting units 74 that surround the wheelchair space 36. These light emission signals cause the passage light emitting units 72, corresponding to the movement line from the ramp 33 to the wheelchair space 36, and the wheelchair space light emitting units 74, surrounding the wheelchair space 36, to emit light as shown in FIG. 6. In this way, the passenger P, who uses wheelchair W, is notified about the movement line.

The seat arrangement changing system 10 in this embodiment performs the processing as described above. That is, when the receiving unit 100 of the processing server 20 receives a ride-booking request, the determination unit 110 determines whether the passenger P, who has made the ride-booking request, requires the wheelchair space 36. When the determination unit 110 determines that the passenger P requires the wheelchair space 36, the instruction unit 120 sends an instruction to the control device 40 to change the arrangement of the seats 60 for securing the wheelchair space 36 for the passenger P. Therefore, when the passenger P who is a user of the wheelchair W rides on the vehicle 30, the seat arrangement changing system 10 in this embodiment prepares the wheelchair space 36 according to the time when the passenger P gets on the vehicle 30, improving the space efficiency of the vehicle 30.

In addition, the processing server 20 in this embodiment can determine the arrangement of the seats 60 using the learned model 220 obtained by training a neural network model by machine learning. Therefore, the seat arrangement changing system 10 in this embodiment enters the physical information, which is the information on a disabled part of the body, and the device information, which indicates whether to require the wheelchair W, into the learned model, making it possible to prepare the wheelchair space 36 most suitable for the passenger P.

For example, when the passenger P who is disabled in the left side of the body rides on the wheelchair W with the operation lever on the right side, the wheelchair space 36 is prepared on the left side in the vehicle width direction. The wheelchair space 36, if prepared in this way, allows the passenger P to operate the retaining strap on the vehicle 30 with the right hand and prevents the operation lever from interfering with the vehicle body. Furthermore, when a plurality of passengers P using the wheelchair W ride on the vehicle 30, the wheelchair space 36 for the passenger P whose ride section is longer (that is, the ride time is longer) is prepared on the more rear side of the vehicle. Thus, when the passenger P of the wheelchair W who gets on the vehicle 30 later and gets off the vehicle 30 earlier moves through the passage 38, this arrangement prevents the movement from being disturbed by the wheelchair W of the passenger P who gets on the vehicle 30 earlier.

Optimizing the arrangement of the wheelchair space 36 as described above reduces the time required for the passage of the wheelchair W and the passenger P and the time required for fixing the wheelchair W, making it possible to use the vehicle 30 more smoothly. In addition, this embodiment can optimize the arrangement of the wheelchair space 36 based on the other physical information such as the sex, age, height, and weight, the information on other passengers who have made a ride-booking request, the meteorological information such as the weather, the information on the events on the traveling route of the vehicle 30, and the like.

In addition, the control device 40 in this embodiment, mounted on the vehicle 30, causes the output unit 170 to display the movement line of the passenger P between the ramp 33 and the wheelchair space 36 on the floor 32. This movement line allows the passenger P heading toward the wheelchair space 36 to move in the vehicle cabin 31 without hesitation. In particular, the passage light emitting units 72 and the wheelchair space light emitting units 74 show, by light, the movement line of the passenger P and the wheelchair space 36 to which the passenger P moves. This allows not only the passenger P to move smoothly but also the other passengers around the passenger P to recognize the movement of the passenger P who uses the wheelchair W.

### Second Embodiment

In the first embodiment, the processing server 20 is configured to perform the reception processing, whereas in the second embodiment, the vehicle 30 can perform the reception processing. The following describes the differences from the first embodiment. The same reference numeral is used to denote the same component of the first embodiment, and the further description of that component will be omitted.

The seat arrangement changing system 10 in this embodiment can be configured only by the control device 40, provided in the vehicle 30, and the communication terminal 50. That is, the control device 40 in this embodiment acquires the booking information from the communication terminal 50 to perform the reception processing, changes the arrangement of the seats 60, and causes the lighting device 70 to emit light to indicate the movement line of the passenger P.

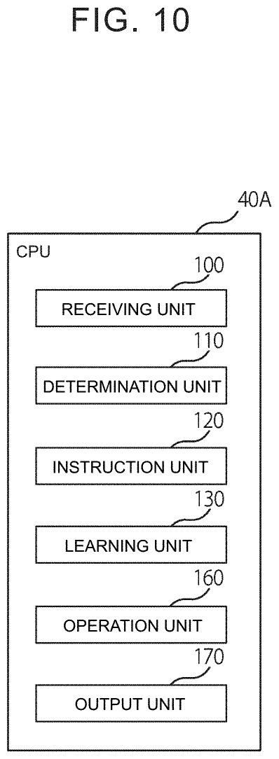

FIG. 10 is a block diagram showing an example of a functional configuration of a CPU 40A in this embodiment. As shown in FIG. 10, the CPU 40A includes the receiving unit 100, determination unit 110, instruction unit 120, learning unit 130, operation unit 160, and output unit 170. Each functional configuration is implemented by reading the control program 250 from the ROM 40B for execution.

According to the embodiment, the control device 40 of the vehicle 30 performs the reception processing and, therefore, the processing server 20 is not necessary. In addition, the blockchain technique is used to connect a plurality of the control devices 40 to each other. This makes it possible to request the control device 40 of another vehicle 30 to book the vehicle 30 on which to ride. Except for this function, this embodiment can achieve the same operation and effect as those of the first embodiment.

### Third Embodiment

Most of the main functions of the seat arrangement changing system 10 are included in the control device 40 in the second embodiment, while most of the main functions are included in the processing server 20 in the third embodiment. The same reference numeral is used to denote the same component of the first and second embodiments, and the further description of that component will be omitted.

In the processing server 20 in this embodiment, the CPU 20A includes the receiving unit 100, determination unit 110, instruction unit 120, learning unit 130, operation unit 160, and output unit 170. This embodiment can achieve the same operation and effect as those of the first embodiment.

### Fourth Embodiment

In determining the wheelchair space 36, the learned model 220 is used in the first embodiment, while an arrangement table (not shown) is used in the fourth embodiment. The differences from the first embodiment will be described below. The same reference numeral is used to denote the same component of the first embodiment, and the further description of that component will be omitted.

In the storage 20D of the processing server 20 in this embodiment, an arrangement table (not shown) defining the arrangement information corresponding to the physical information and the device information is stored instead of the learning data 210 and the learned model 220.

For example, when the physical information includes the information indicating that the lower limb is disabled and the device information includes the information related to the wheelchair W, the corresponding position of the wheelchair space 36 is specified in advance in the arrangement table. Using this arrangement table, the processing server 20 in this embodiment can prepare the wheelchair space 36 at a position close to the ramp 33. When the number of slidable seats 60 is limited or the number of seats in the vehicle 30 is small, the position of the wheelchair space 36 can be optimized using table data such as that used in this embodiment.

### Remarks

In each of the embodiments described above, the output unit 170 causes the passage light emitting units 72, which correspond to the movement line of the passenger P, and the wheelchair space light emitting units 74, which correspond to the wheelchair space 36, to emit light based on the arrangement information. The light emitting operation of the passage light emitting units 72 and the wheelchair space light emitting units 74, performed by the output unit 170, is not limited to a simple lighting operation; instead, the light emitting operation may be a blinking operation. In particular, the plurality of passage light emitting units 72 may be turned on in the following order. The passage light emitting units 72 may be turned on in the order from the ramp 33 toward the wheelchair space when the passenger P gets on the vehicle, and in the order from the wheelchair space 36 to the ramp 33 when the passenger P gets off the vehicle. Turning on the light emitting units in this order assists in the movement of the passenger P.

The wheelchair space 36 in each embodiment is a space used for a mobility device such as a wheelchair W but is not limited thereto; the space may be used for a space for storing luggage. In this case, the position of the space can be optimized by using the corner of the vehicle cabin 31 as a storage space of large luggage so as not to obstruct the passage of other passengers or by using the space next to the seat 60 of a luggage-carrying passenger as a storage space.

In the embodiments described above, the CPU 20A or 40A reads the software (programs) for performing various types of processing. This processing may also be performed by various types of processors other than the CPU. Examples of such processors include a programmable logic device (PLD), such as a field-programmable gate array (FPGA), in which the circuit configuration can be changed after the circuit is fabricated and a specific electric circuit, such as an application specific integrated circuit (ASIC), that is a processor having a circuit configuration specifically designed for performing specific processing. The reception processing described above may be performed by one of these various processors or by a combination of two or more processors of the same type or different types (for example, a plurality of FPGAs or a combination of a CPU and an FPGA). More specifically, the hardware structure of these various processors is an electric circuit fabricated by combining circuit elements such as semiconductor elements.

In the embodiments described above, the programs are stored (installed) in advance in a non-transitory recording medium readable by a computer. For example, in the processing server 20, the processing programs 200 are stored in the storage 20D in advance. Similarly, in the control device 40, the control program 250 is stored in the ROM 40B in advance. However, in the present disclosure, the programs need not always be stored in this manner. That is, the programs may be distributed on a non-volatile temporary memory such as a compact disc read only memory (CD-ROM), a digital versatile disc read only memory (DVD-ROM), and a universal serial bus (USB) memory. In addition, the programs may be downloaded from an external device via a network.

What is claimed is:

1. A processing device comprising:
a receiving unit configured to receive a ride-booking request to ride on a vehicle;
a determination unit configured to determine whether a passenger requires a wheelchair space for a mobility device used by the passenger, the passenger having booked the ride-booking request received by the receiving unit; and
an instruction unit configured to give an instruction to change an arrangement of seats in order to secure the wheelchair space for the passenger when the determination unit determines that the wheelchair space is required.

2. The processing device according to claim 1, wherein the determination unit is configured to determine the wheelchair space based on physical information on the passenger and device information on the mobility device used by the passenger.

3. The processing device according to claim 1, wherein the determination unit is configured to determine the wheelchair space based on physical information on the passenger and device information on the passenger that are input to a learned model, the learned model being generated using physical information on users who require the wheelchair space when getting on the vehicle and device information relating to mobility devices used by the users.

4. A processing system comprising:
the processing device according to claim 1; and
an output unit configured to display, on a floor of the vehicle, a movement line between a ramp of the vehicle and the wheelchair space when the passenger who requires the wheelchair space gets on the vehicle or gets off the vehicle.

5. The processing system according to claim 4, wherein the output unit is configured to cause light emitting units corresponding to the movement line and light emitting units surrounding the wheelchair space to emit light, the light emitting units constituting a plurality of light emitting units installed on the floor.
